(19) United States
(12) Patent Application Publication
(10) Pub. No.: US 2003/0131692 A1
(43) Pub. Date: Jul. 17, 2003

(54) Socket wrench

(76) Inventor: Hsiu-Ching Huang, Taipei (TW)

Correspondence Address: Alan D. Kamrath, Rider, Bennett, Egan & Arundel. LLP, Suite 2000, 333 South Seventh Street, Minneapolis, MN, 55402, US

(21) Appl. No.: 10/073,535

(22) Filed: Feb. 11, 2002

(30) Foreign Application Priority Data
Jan. 11, 2002 (TW) 91200242

(51) Int. Cl. B25B 13/46

(52) U.S. Cl. 81/60

(57) ABSTRACT

A socket wrench includes a group of spanners and a joint. Each of the spanners includes an elongated body, an annular head, a driving element received in the annular head and a ratchet mechanism arranged between the annular head and the driving element in order to selectively provide a one-way rotation of the driving element while the spanner is swayed. The driving element defines a joint-engaging hole. The joint includes integrated spanner-engaging sections and socket-engaging section. Each of the spanner-engaging sections includes a size conforming to that of one of holes. The socket-engaging section includes a shape and size corresponding to that of a socket. Thus, each of the spanner-engaging sections can be engaged with the joint-engaging hole defined in a corresponding one of the spanners. Moreover, the socket wrench includes a bolt-engaging hole defined in a furthest one of the spanner-engaging sections from the socket-engaging section so as to engage with a head of a bolt.

### BACKGROUND OF INVENTION

1. Field of Invention

The present invention is related to a socket wrench and, more particularly, to a socket wrench including a joint capable of selectively connecting with one of spanners of various sizes and capable of connecting with a head of a bolt

2. Related Prior Art

Today, a lot of household stuffs, furniture, machines, tools, and etc. include a number of components assembled by means of bolts and nuts. For engagement or disengagement of such components, they are often driven by means of wrenches (or “spanner”). Therefore, mechanics keep a lot of sockets at work. People have gotten used to the idea of keeping wrenches at home.

A wrench includes an elongated body and two enlarged heads each defining an opening or hexagonal hole for engagement with a head of a bolt. Each head of a wench is used to drive only a bolt of a specific size.

Two conventional types of socket wrenches have been devised. In one type, socket wrenches all include an elongated body and two sockets each for engagement with a head of a bolt. Each socket is used to drive only a bolt of a specific size. In the other type, a spanner connected with one of sockets of various sizes via a joint.

FIG. 9 shows a conventional socket wrench including a spanner 4, a socket 6 and a joint 1 for connecting the spanner 4 with the socket 6. The spanner 4 includes an elongated body and an enlarged head defining a star-shaped hole 5. The joint 1 includes a hexagonal section 2 and a square section 3. The hexagonal section 2 is used for engagement with the star-shaped hole 5. The socket 6 defines a square hole 7 at an end and a hexagonal hole at the other end. The square section 3 of the joint 1 is used for insertion in the square hole 7 defined in the socket 6. The hexagonal hole defined in the socket 6 is used for engagement with a hexagonal head of a bolt. The size of the square section 3 of the joint 1 must match that of the square hole 7 defined in the socket 6 so that the joint 1 can positively rotate the socket 6. Depending upon intended strength and size, two series of sockets such as socket 6 are devised. In one series, the sockets include a square hole with a dimension of ½ inch. In the other series, the sockets include a square hole with a dimension of ⅜ inch. Therefore, for engagement with such the two series of sockets, respectively, there must be two joints such as joint 1, one including a square section with a dimension of ½ inch while the other including a square section with a dimension of ⅜ inch. While working, a person often has to select sockets from the two series and is forced to replace a joint of one size with the other joint of the other size. A drawback for using such a conventional socket wrench is that purchasing two joints is not cost effective. A second drawback for using such a conventional socket wrench is the trouble in replacing a joint with the other.

The present invention is therefore intended to obviate or at least alleviate the drawbacks encountered in using conventional socket wrenches.

### SUMMARY OF INVENTION

It is the primary objective of the present invention to provide a socket wrench including a joint capable of engagement with spanners of various sizes.

To achieve the above-mentioned and other objectives, the present invention provides a socket wrench including a group of spanners and a joint. Each of the spanners includes an elongated body, an annular head, a driving element received in the annular head and a ratchet mechanism arranged between the annular head and the driving element in order to selectively provide a one-way rotation of the driving element while the spanner is swayed. The driving element defines a joint-engaging hole. The joint includes integrated spanner-engaging sections and socket-engaging section. Each of the spanner-engaging sections includes a size conforming to that of one of holes. The socket-engaging section includes a shape and size corresponding to that of a socket. Thus, each of the spanner-engaging sections can be engaged with the joint-engaging hole defined in a corresponding one of the spanners.

In an aspect, the socket wrench includes a bolt-engaging hole defined in a furthest one of the spanner-engaging sections from the socket-engaging section so as to engage with a head of a bolt.

### BRIEF DESCRIPTION OF DRAWINGS

FIG. 1 is a perspective view of a socket wrench according to the present invention, showing a joint disengaged from a first spanner of a first size, while omitting a socket;

FIG. 2 is an enlarged view of the socket wrench shown in FIG. 1, but showing joint engaged with the first spanner, some portions being broken away for giving details;

FIG. 3 is a side view of the socket wrench shown in FIG. 2, showing the joint further engaged with a socket;

FIG. 4 is a side view of the socket wrench shown in FIG. 2, showing the joint further engaged with a head of bolt;

FIG. 5 is a view similar to FIG. 2, but showing the joint engaged with a second spanner of a second size;

FIG. 6 is a side view of the socket wrench shown in FIG. 5, showing the joint further engaged with a socket;

FIG. 7 is a side view of the socket wrench shown in FIG. 5, showing the joint further engaged with a head of bolt;

FIG. 8 is a view similar to FIG. 2, but showing a socket wrench according to a second embodiment of the present invention; and

FIG. 9 is an exploded view of socket wrench according to prior art.

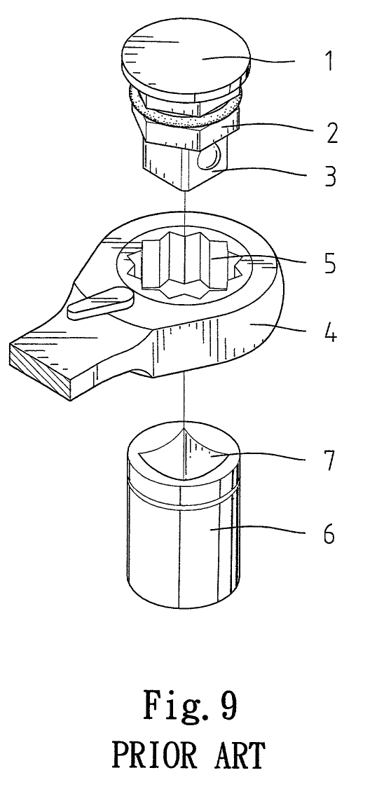

### DETAILED DESCRIPTION OF PREFERRED EMBODIMENTS

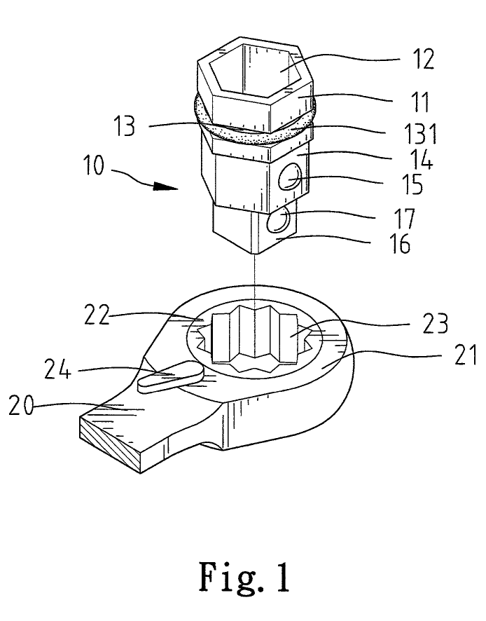

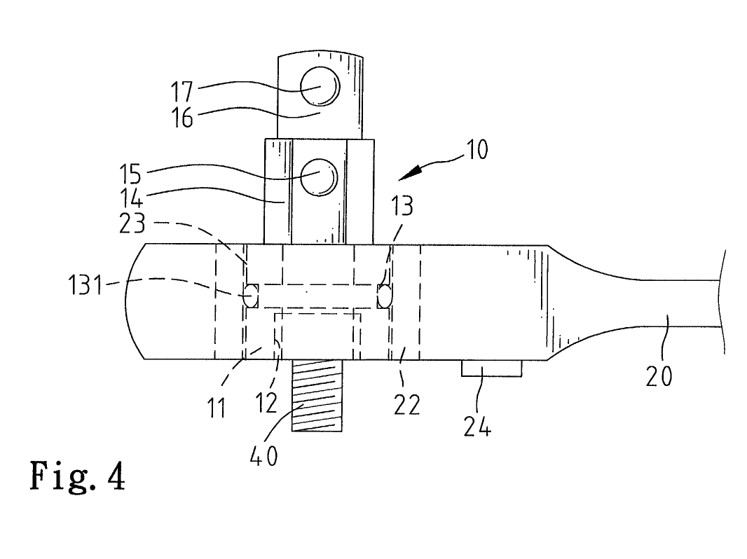

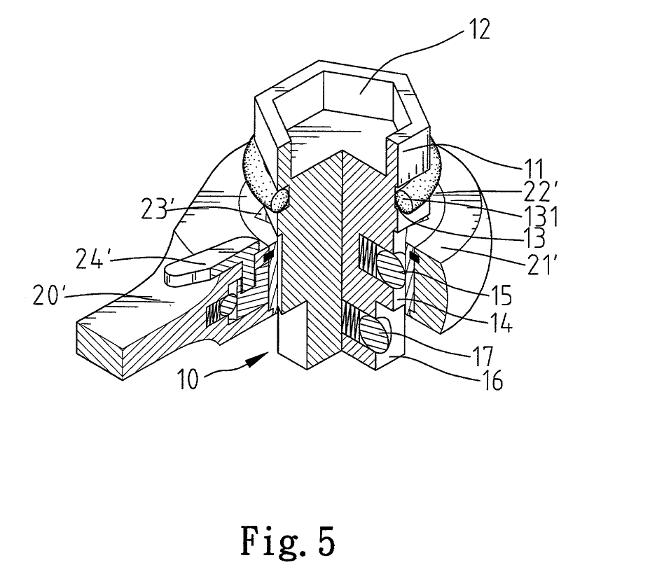

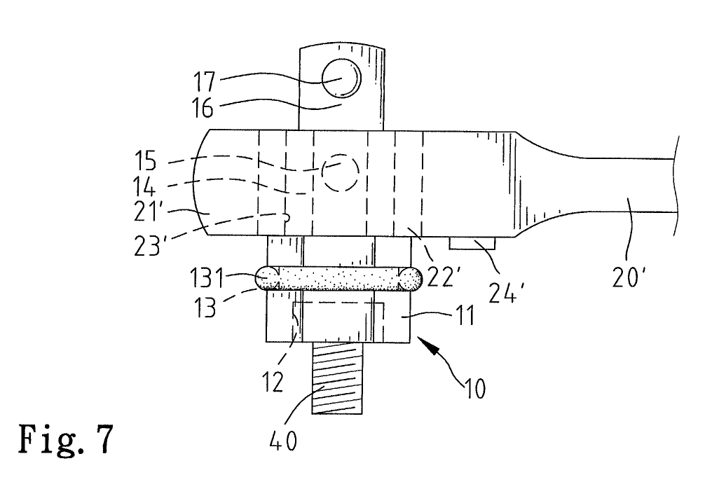

FIGS. 1 through 7 show a socket wrench according to a preferred embodiment of the present invention. The socket wrench includes a joint 10 and a spanner. The spanner may be a spanner 20 shown in FIGS. 1 through 4 or a spanner 20′ shown in FIGS. 5 through 7. The joint 10 is capable of selectively connecting with one of the spanners 20 and 20′ and capable of connecting with a head of a bolt such as that is referenced by “40” shown in FIGS. 4 and 7.

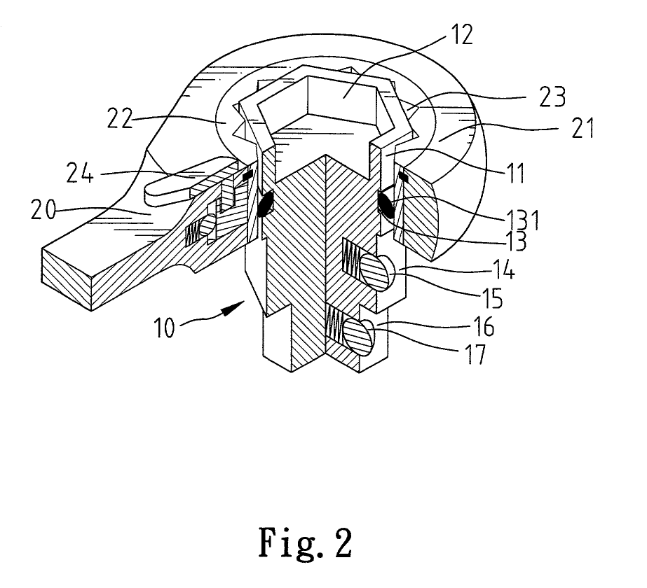

Referring to FIGS. 1 through 4, the spanner 20 includes an elongated body (only a portion thereof is shown) and an annular head (not numbered). A driving element 22 is received in the annular head of the spanner 20. As shown in FIG. 2, a ratchet mechanism (not numbered) is arranged between the driving element 22 and the annular head of the spanner 20 in order to selectively provide a one-way rotation of the driving element 22 while the spanner 20 is swayed. The ratchet mechanism includes a switch 24 for selection of the direction in which the spanner 20 drives the driving element 22. The ratchet mechanism is conventional and therefore is not described in detail. The driving element 22 defines a star-shaped hole 23. The star-shaped hole 23 includes a size of 19 mm.

Referring to FIGS. 5 through 7, the spanner 20′ includes an elongated body (only a portion thereof is shown) and an annular head (not numbered). A driving element 22′ is received in the annular head of the spanner 20′. As shown in FIG. 5, a ratchet mechanism (not numbered) is arranged between the driving element 22′ and the annular head of the spanner 20′ in order to selectively provide a one-way rotation of the driving element 22′ while the spanner 20′ is swayed. The ratchet mechanism includes a switch 24′ for selection of the direction in which the spanner 20′ drives the driving element 22′. The ratchet mechanism is conventional and therefore is not described in detail. The driving element 22′ defines a star-shaped hole 23′. The star-shaped hole 23′ includes a size of 17 mm.

The spanners 20 and 20′ are identical to each other regarding both structure and function except for including different sizes. Conventionally, the spanners 20 and 20′ require different joints. However, in the present invention, a signal joint is devised to selectively connect with one of the spanners 20 and 20′.

The joint 10 includes in sequence a first hexagonal section 11, a second hexagonal section 14 formed at an end of the first hexagonal section 11 and a square section 16 formed at an end of the second hexagonal section 14.

Referring to FIGS. 2 through 4, the first hexagonal section 11 includes an external size corresponding to that of the star-shaped hole 23. Thus, the first hexagonal section 11 can be inserted in the star-shaped hole 23 so that the joint 10 can be driven by means of the driving element 22. This hexagonal section 11 defines an annular groove 13 for receiving a ring 131 made of elastic material. The ring 131 is used to ensure engagement of the joint 10 with the spanner 20.

The first hexagonal section 11 defines a hexagonal hole 12, thus rendering the first hexagonal section 11 a socket. Referring to FIGS. 4 and 7, the first hexagonal section 11 includes an internal size corresponding to that of a head of a bolt 40 so that the head of the bolt 40 can be received in the hexagonal hole 12 defined in the first hexagonal section 11 and that the bolt 40 can be driven by means of the hexagonal section 11.

Referring to FIGS. 5 through 7, the second hexagonal section 14 includes a size corresponding to that of the second star-shaped hole 23′. Thus, the second hexagonal section 14 can be inserted in the second star-shaped hole 23′ so that the driving element 22′ can drive the joint 10. The second hexagonal section 14 includes a spring-biased ball 15 for ensuring engagement of the joint 10 with the spanner 20′.

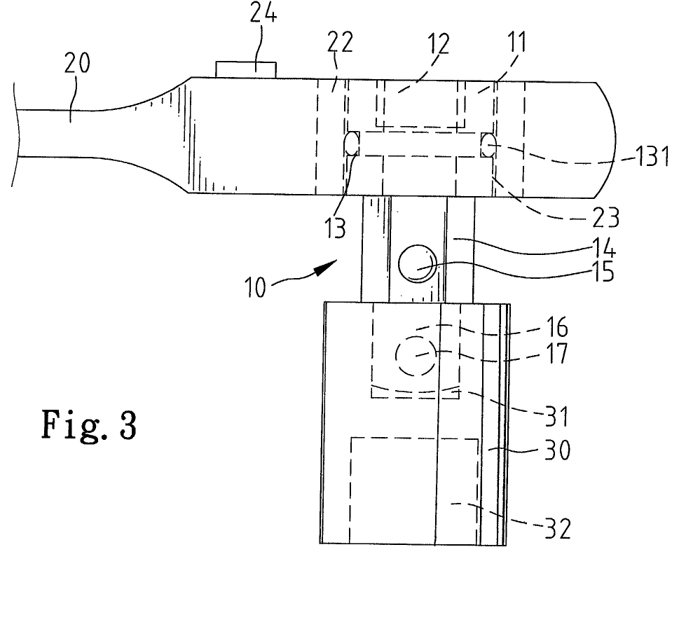

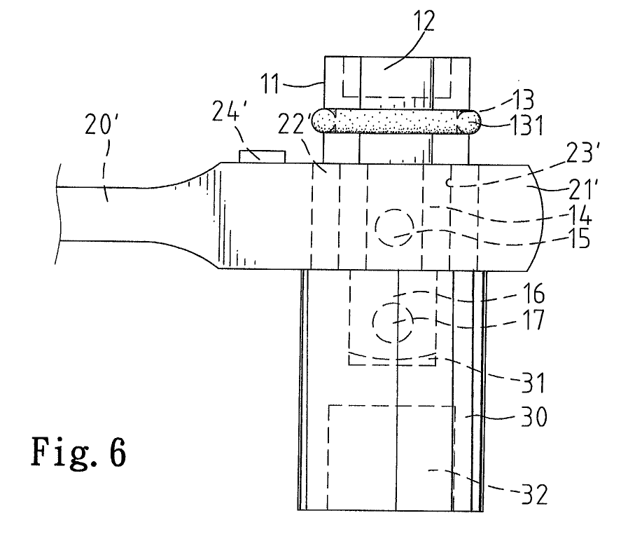

Referring to FIGS. 3 and 6, the square section 16 of the joint 10 includes a size corresponding to that of a square hole 31 defined in an end of a socket 30 so that the square section 16 can be inserted in the square hole 31 and that the joint 10 can drive the socket 30. The socket 30 further defines a hexagonal hole 32 in an opposite end for engagement with the head of the bolt 40. The square section 16 includes a spring-biased ball 17 for ensuring engagement of the joint 10 with the socket 30.

The spring-biased balls 15 and 17 are identical to each other with respect to structure and function. Such a ball is partially received in a recess defined in the joint 10 and biased by means of a spring received in the same recess. The common arrangement related to the spring-biased balls 15 and 17 is conventional and therefore further details thereof are not given.

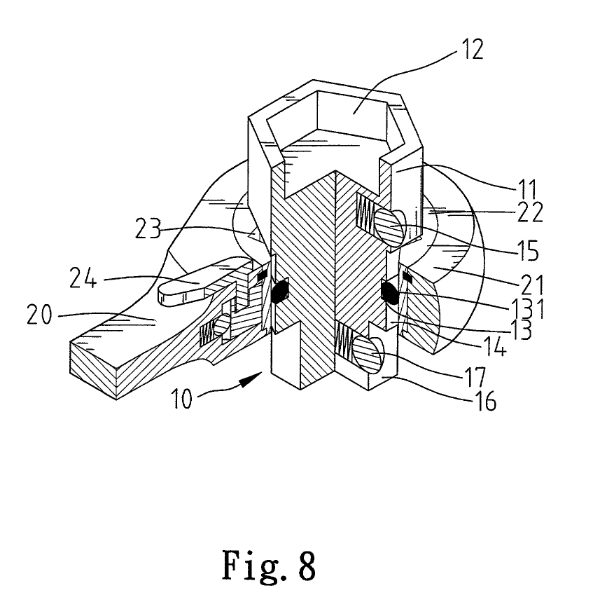

FIG. 8 shows a socket wrench according to another embodiment of the present invention. It is identical to the first embodiment shown in FIGS. 1 through 7 except that the location of the spring-biased ball 15 and that of the ring 131 are exchanged. The ring 131 and the spring-biased balls 15 and 17 can all used to ensure the engagement of two components. Other appropriate devices can be used to ensure such engagement. The engagement-ensuring device used in each section of the joint 10 can be identical to or different from that used in another section of the same.

Some embodiments of the present invention have been described in detail only for purposes of example and illustration. Those skilled in the art can derive a lot of variations from these embodiments after a study of this patent specification. Therefore, these embodiments shall by no means limit the scope of the present invention. The scope of the present invention can only be defined in the following claims attached to and taken as a portion of this patent specification.

1. A socket wrench comprising:
a group of spanners (20; 20′) each including an elongated body, an annular head, a driving element (22; 22′) received in the annular head and a ratchet mechanism arranged between the annular head and the driving element (22; 22′) in order to selectively provide a one-way rotation of the driving element (22; 22′) while the spanner (20; 20′) is swayed, the driving element (22; 22′) defining a hole (23; 23′);
joint (10) including integrated spanner-engaging sections (11; 14) and socket-engaging section (16), each of the spanner-engaging sections (11; 14) including a size conforming to that of one of holes (23; 23′), the socket-engaging section including a shape and size corresponding to that of a socket (40).

2. The socket wrench as set forth in claim 1 wherein the hole (23) is shaped as a star.

3. The socket wrench as set forth in claim 1 wherein at least one of the spanner-engaging sections (11; 14) is shaped as a hexagon.

4. The socket wrench as set forth in claim 1 including an engagement-ensuring device (131; 15; 17) arranged in at least one of the spanner-engaging sections (11; 14).

5. The socket wrench as set forth in claim 4 wherein the engagement-ensuring device is a ring (131) attached to the spanner-engaging section (11; 14; 16) to ensure engagement of the joint (10) with the spanner (20).

6. The socket wrench as set forth in claim 5 wherein the ring (131) is made of an elastic material.

7. The socket wrench as set forth in claim 5 wherein the spanner-engaging section (11; 14; 16) defines an annular groove (13) for receiving the ring (131).

8. The socket wrench as set forth in claim 4 wherein the engagement-ensuring device is a spring-biased ball (15; 17) attached to the spanner-engaging section (11; 14; 16) to ensure engagement of the joint (10) with the spanner (20).

9. The socket wrench as set forth in claim 8 wherein the engagement-ensuring device includes:
a recess defined in the spanner-engaging section (11; 14) so that the ball (15; 17) is partially received therein; and
a spring received in the recess defined in the spanner-engaging section (11; 14) for biasing the ball (15; 17).

10. The socket wrench as set forth in claim 1 wherein the socket-engaging section (16) is shaped as a square.

11. The socket wrench as set forth in claim 1 including a bolt-engaging hole (12) defined in a furthest one (11) of the spanner-engaging sections from the socket-engaging section (16) in order to engage with a head of a bolt (40).
